(19) United States
(12) Patent Application Publication
(10) Pub. No.: US 2008/0280599 A1
(43) Pub. Date: Nov. 13, 2008

(54) CALL PROCESSING METHOD AND SYSTEM

(75) Inventor: Jing-Ru Cheng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/745,623

(22) Filed: May 8, 2007

(51) Int. Cl. H04M 3/42; H04M 1/00

(52) U.S. Cl. 455/415; 455/567

(57) ABSTRACT

A mobile communication terminal is provided. A storage unit stores a disconnect cause associated with caller information. A communication unit receives an incoming call. A controller determines whether the incoming call is associated with the caller information, disconnects the incoming call if the incoming call is associated with the caller information, and sends a disconnect message indicating the disconnect cause to a network station relaying the incoming call.

### BACKGROUND

The invention relates to call processing, and in particular to a call processing method implemented in a mobile communication terminal and a mobile communication terminal using the same.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

Conventionally, when an incoming call is received in a mobile communication terminal, and a subscriber does not want to answer the call, a network station automatically relays an incoming call response informing the caller of the disconnect cause given by the network station. Under some circumstances, the subscriber, for the sake of courtesy, prefers to disguise the reason for ignoring the call. Under some circumstances, a particular disconnect cause, such as “invalid number format”, may prevent the subscriber from annoyance due to subsequent prank calls. Conventional call processing mechanisms, however, do not allow subscribers to select and/or set a disconnect cause when disconnecting from particular incoming calls, causing inconvenience for users.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A call processing method, implemented in a mobile communication terminal, is provided. A disconnect cause is provided. The disconnect cause is associated with caller information. An incoming call is received. It is determined whether the incoming call is associated with the caller information. The incoming call is disconnected if the incoming call is associated with the caller information. A disconnect message is sent to a network station relaying the incoming call, indicating the disconnect cause.

A call processing method, implemented in a mobile communication terminal is provided. A plurality of disconnect causes are provided. An incoming call is received. A prompt is provided to a user to select one of a plurality of disconnect causes. The incoming call is disconnected. A disconnect message is sent to a network station relaying the incoming call, indicating the selected disconnect cause.

A mobile communication terminal is provided. A storage unit stores a disconnect cause associated with caller information. A communication unit receives an incoming call. A controller determines whether the incoming call is associated with the caller information, disconnects the incoming call if the incoming call is associated with the caller information, and sends a disconnect message indicating the disconnect cause to a network station relaying the incoming call.

A mobile communication terminal is provided. A storage unit stores a plurality of disconnect causes. A communication unit receives an incoming call. A controller prompts a user to select one of the plurality of disconnect causes, disconnects the incoming call, and sends a disconnect message indicating the selected disconnect cause to a network station relaying the incoming call.

### BRIEF DESCRIPTION OF DRAWINGS

The invention can be more fully understood by reading the subsequent detailed description and examples with references made to the accompanying drawings, wherein:

FIG. 1 illustrates a schematic view of an embodiment of a mobile communication terminal;

FIG. 2 is a flowchart of an embodiment of a call processing method;

FIG. 3 illustrates a schematic view of an embodiment of a mobile communication terminal;

FIGS. 4A and 4B are flowcharts of two embodiments of a call processing method;

FIG. 5 illustrates a schematic view of operation in a network system; and

FIGS. 6A˜6C illustrate embodiments of disconnect messages.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

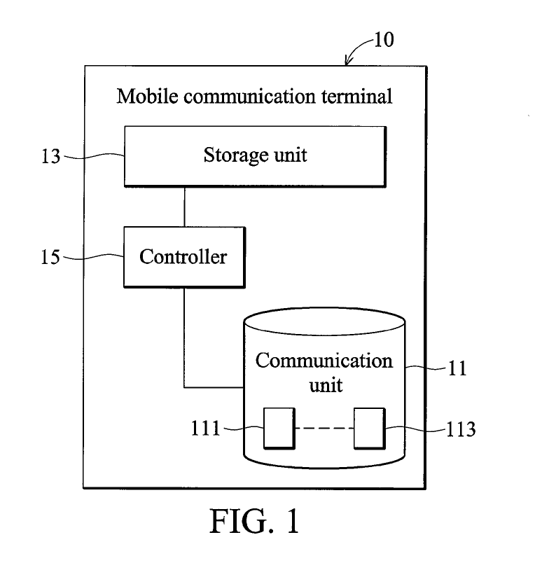

The invention is now described with reference to FIGS. 1 through 6, which generally relate to controlling call processing. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

FIG. 1 illustrates a schematic view of an embodiment of a mobile communication terminal. A mobile communication terminal 10 comprises a storage unit 11, a communication unit 13, and a controller 15.

The storage unit 11 stores at least one entry of caller information 113 and at least one disconnect cause 111 associated thereto.

The caller information 113 can comprise various data to meet requirements. For example, the caller information 113 can specify caller identification or a time period corresponding to an incoming call. The caller identification can specify a telephone number or a name for identifying a caller.

For caller information 113 specifying caller identification of an incoming call, the controller 15 disconnects the incoming call associated with the caller identification, and sends a disconnect message indicating the disconnect cause 111. A user can directly input caller identification or select caller identification from a pre-stored phonebook or call log, and then set one of the at least one disconnect cause 111 to the caller identification.

For caller information 113 specifying a time period, the controller 15 disconnects the incoming call received during the time period, and sends a disconnect message indicating the disconnect cause 111. A user can directly set a time period, and then set one of the at least one disconnect cause 111 to the caller identification.

The disconnect cause 111 can be set to meet requirements, for example, the cause can be an invalid number format, changed number, or temporary network failure.

In addition, the storage unit 11 caches information pertaining to the automatically disconnected incoming call as a missed call for later retrieval.

The communication unit 13 receives an incoming call. The controller 15 determines whether the incoming call is associated with the caller information 113, disconnects the incoming call if the incoming call is associated with the caller information 113, and sends a disconnect message indicating the disconnect cause 111 to a network station relaying the incoming call.

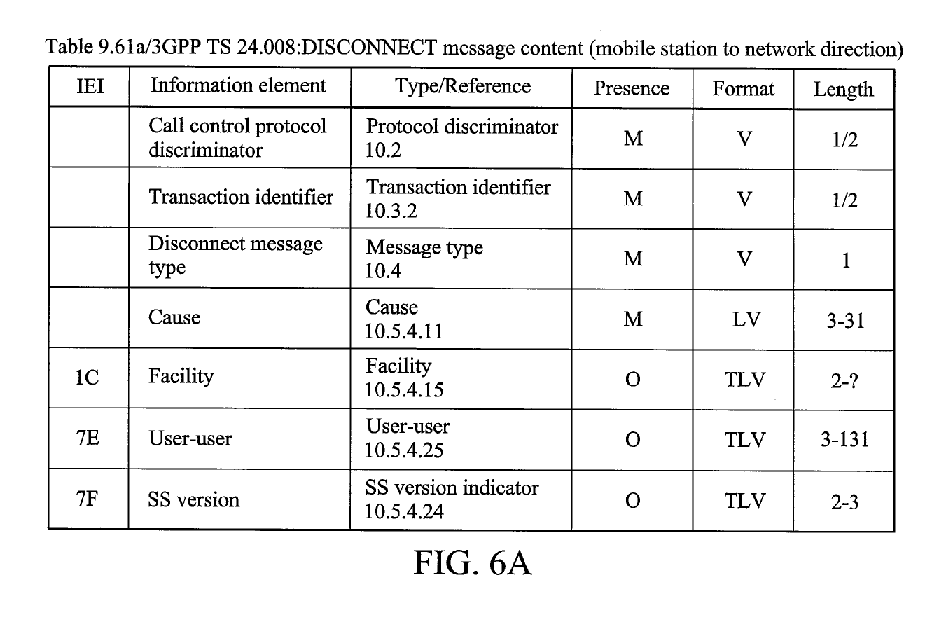

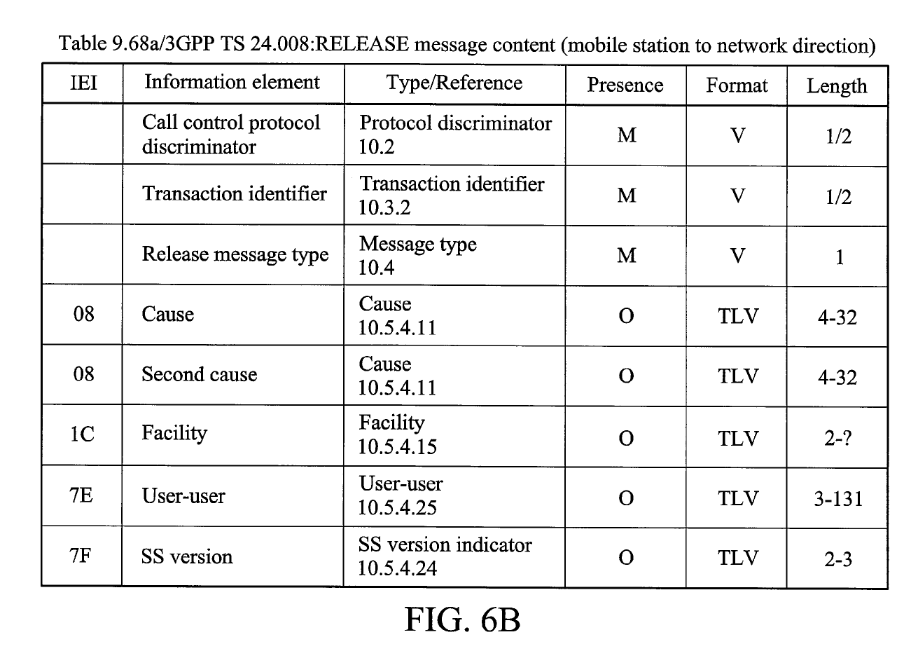

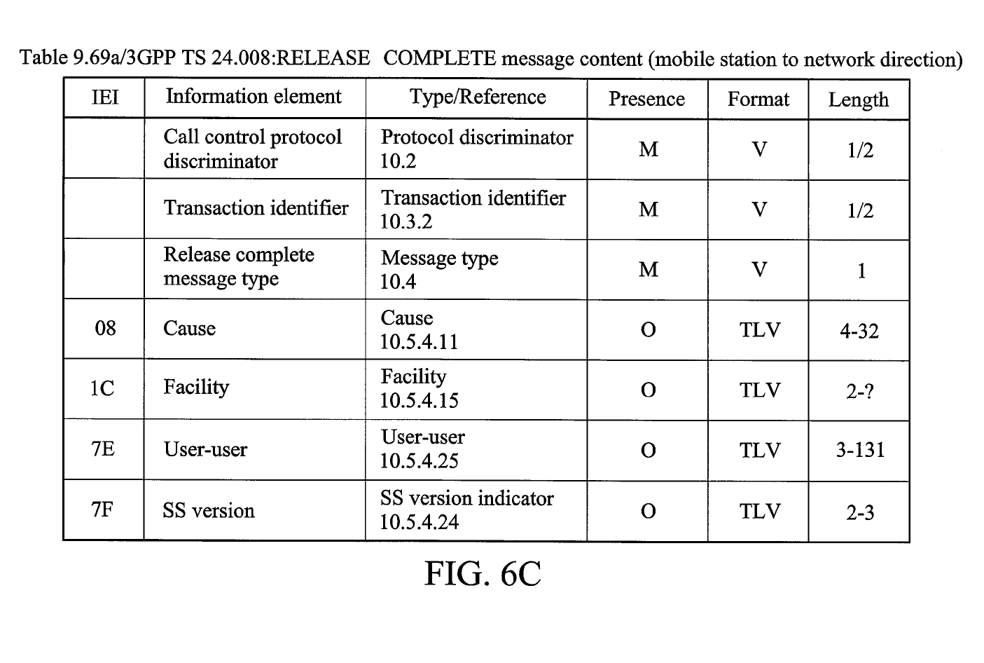

The disconnect message sent by controller 15 can be disconnect, release, or release complete message as defined in the 3GPP (Third Generation Partnership Project) standard. According to 3GPP standard, disconnect, release, and release complete messages comprise contents shown in FIGS. 6A˜6C. Referring to FIGS. 6A˜6C, the “cause element” of each of the messages can specify a user-defined disconnect cause, indicating the associated disconnect cause 111.

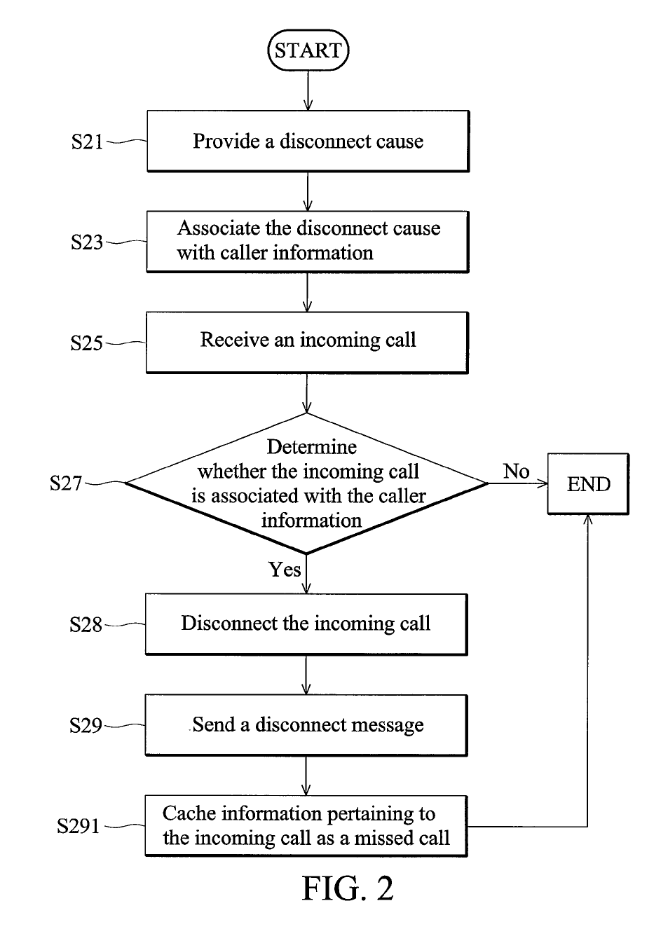

FIG. 2 is a flowchart of an embodiment of a call processing method. The method of FIG. 2 can be implemented in the mobile communication terminal of FIG. 1. In step S21, a disconnect cause is provided. The disconnect cause can be set to meet requirements, for example, it can be an invalid number format, changed number, or temporary network failure.

The disconnect cause is associated with caller information (step S23). In steps S21 and S23, at least one entry of caller information 113 and at least one disconnect cause 111 associated thereto are provided. An incoming call is received (step S25). In step S27, it is determined whether the incoming call is associated with the caller information set in step S21, and if so, the method proceeds to step S28, otherwise, the method ends.

In step S28, the incoming call is disconnected. In step S29, a disconnect message, indicating the disconnect cause, is sent to a network station relaying the incoming call.

Caller information can, for example, specify caller identification information of an incoming call, and the incoming call associated with the caller identification information is disconnected. Here, the caller identification information can specify a telephone number for identifying a caller. A user can determined a blacklist comprising caller information corresponding to marketing calls, and set a disconnect cause, such as an invalid number format, for the specific caller information. As a result, when an incoming call from the specific caller information is received, the incoming call is automatically disconnected, and the caller is informed of the preset disconnect cause. For example, if “an invalid number format” is adopted as the disconnect cause, the caller is informed that the called phone number is an invalid number format, and may stop calling the phone number.

In some embodiments, the caller information can specify a time period, and the incoming call received during the time period is disconnected. For example, this feature can be implemented when a user is engaged in a meeting. A time period corresponding to the meeting time, as well as a specific disconnect cause are determined by a user, and the incoming call received during the time period is disconnected. In addition, the caller of the incoming call is informed of the specific disconnect cause, such as a “temporary network failure”. By doing so, meeting disruptions due to incoming calls can be avoided, and the caller is put under the impression that temporary network failure has occurred.

In addition, in step S291, information pertaining to the automatically disconnected incoming call is cached as a missed call for later retrieval.

The disconnect message sent by controller 15 can be disconnect, release, or release complete message as defined in the 3GPP (Third Generation Partnership Project) standard. According to the 3GPP standard, disconnect, release, and release complete messages comprise contents shown in FIGS. 6A˜6C. Referring to FIGS. 6A˜6C, the “cause element” of each of the messages can specify a user-defined disconnect cause, indicating the associated disconnect cause 111.

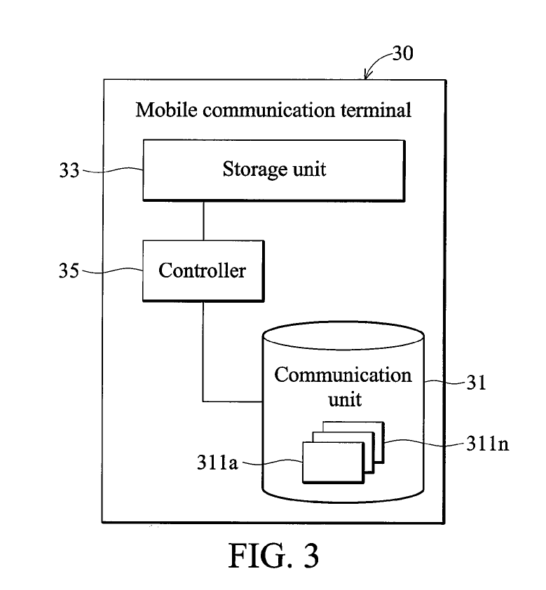

FIG. 3 illustrates a schematic view of an embodiment of a mobile communication terminal. A mobile communication terminal 30 comprises a storage unit 31, a communication unit 33, and a controller 35.

The storage unit 31 stores a plurality of disconnect causes 311a-311n. The communication unit 33 receives an incoming call and initiates a call. The controller 35 prompts a user to determine whether to disconnect the incoming call or the initiated call. If the initiated call or the incoming call is determined to be disconnected, the controller 35 prompts the user to select one of disconnect causes 311a-311n, disconnects the incoming call, and sends a disconnect message indicating the selected disconnect cause to a network station relaying the incoming call. (Ripple: is this segment means “relaying the cause to the calling side?)

The controller 35 can disconnect the initiated call or the incoming call before a call session is initiated or during a call session.

In addition, the storage unit 31 caches information pertaining to the disconnected incoming call before initiation of a call session as a missed call for later retrieval.

The disconnect causes 311a˜311n can be set to meet requirements, for example, an invalid number format, changed number, or temporary network failure.

The disconnect message sent by controller 35 can be disconnect, release, or release complete message as defined in the 3GPP (Third Generation Partnership Project) standard. According to 3GPP standard, disconnect, release, and release complete messages comprise contents shown in FIGS. 6A˜6C. Referring to FIGS. 6A˜6C, the “cause element” of each of the messages can specify a user-defined disconnect cause, indicating the selected disconnect cause.

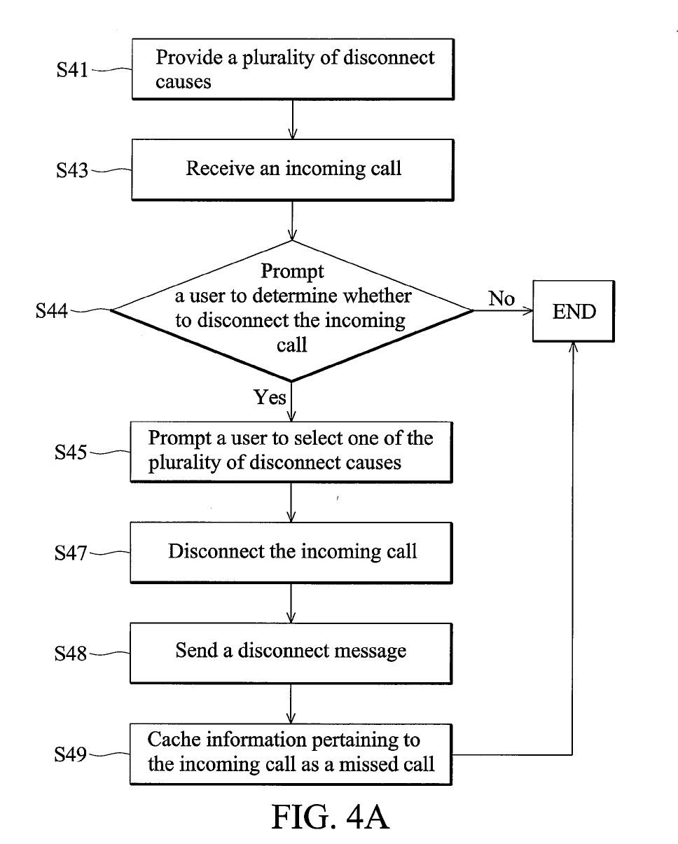

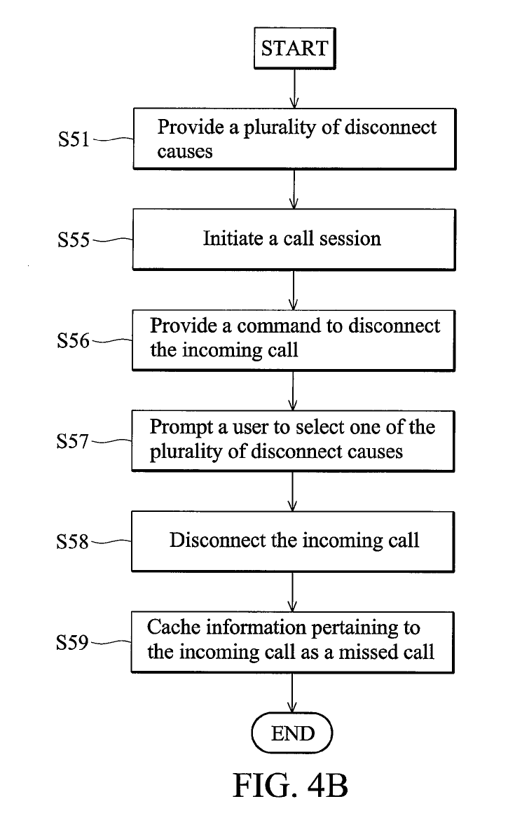

FIGS. 4A and 4B are flowcharts of two embodiment of a call processing method. In the method of FIG. 4A, the controller disconnects the incoming call before a call session is initiated. In the method of FIG. 4B, the controller disconnects the call during a call session. Both the methods of FIGS. 4A and 4B can be implemented in the mobile communication terminal of FIG. 3.

Referring to FIG. 4A, a plurality of disconnect causes are provided (step S41). The disconnect causes can be set to meet requirements, for example, an invalid number format, changed number, or temporary network failure.

An incoming call is received (step S43). In step S44, a pop-up window is provided to prompt a user to determine whether to disconnect the incoming call, and if so, the method proceeds to step S45, otherwise, the method ends. In step S45, a pop-up window is provided to prompt a user to select one of the plurality of disconnect causes.

In step S47, the incoming call is disconnected. In step S48, a disconnect message, indicating the selected disconnect cause, is sent to a network station relaying the incoming call.

In addition, in step S49, information pertaining to the disconnected incoming call is cached as a missed call for later retrieval.

The disconnect message sent by controller 35 can be disconnect, release, or release complete message as defined in the 3GPP (Third Generation Partnership Project) standard. According to 3GPP standard, disconnect, release, and release complete messages comprise contents shown in FIGS. 6A˜6C. Referring to FIGS. 6A˜6C, the “cause element” of each of the messages can specify a user-defined disconnect cause, indicating the selected disconnect cause.

Referring to FIG. 4B, a plurality of disconnect causes are provided (step S51). The disconnect causes can be set to meet requirements, for example, an invalid number format, changed number, or temporary network failure.

In step S54, a call session is initiated. The call session can be initiated in response to an incoming call or a call out operation. During the call session, a command is provided by a user to disconnect the incoming call (step S55). For example, if the user does not want to continue the conversation during a call section, the user can press a specific hard key or soft key to provide the command for disconnecting the call. In step S56, a pop-up window is provided to prompt a user to select one of the plurality of disconnect causes. For example, in step S56, a menu, specifying the disconnect causes provided in step S51, is displayed in response to pressing of a specific hard key or soft key in step S55 for the user to select one of the disconnect causes.

In step S57, the incoming call is disconnected. In step S58, a disconnect message, indicating the selected disconnect cause, is sent to a network station relaying the incoming call.

In addition, in step S59, information pertaining to the incoming call disconnected during the call session is cached as a received call for later retrieval.

The disconnect message sent by controller 35 can be disconnect, release, or release complete message as defined in the 3GPP (Third Generation Partnership Project) standard. According to 3GPP standard, disconnect, release, and release complete messages comprise contents shown in FIGS. 6A˜6C. Referring to FIGS. 6A˜6C, the “cause element” of each of the messages can specify a user-defined disconnect cause, indicating the selected disconnect cause.

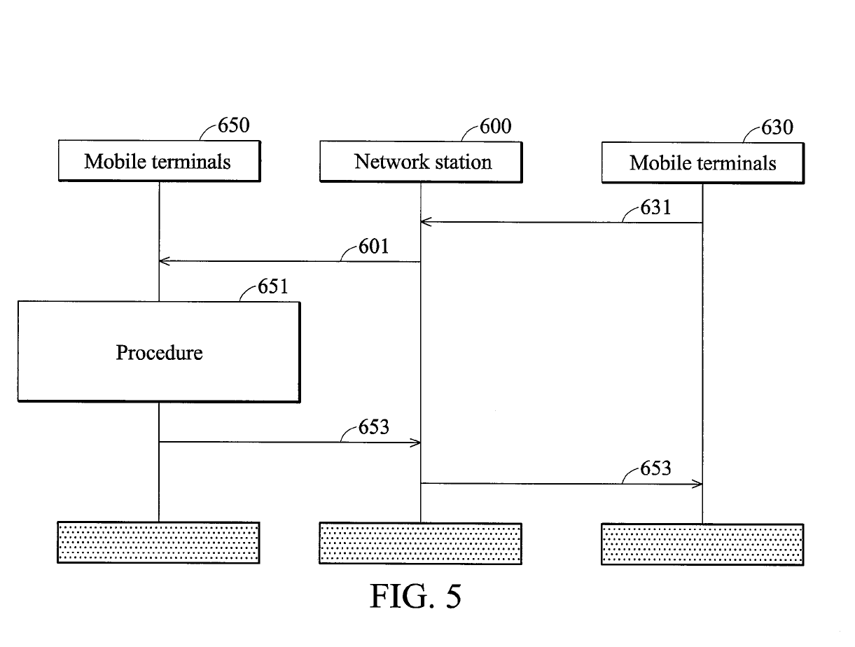

FIG. 5 illustrates a schematic view of operation in a network system. A network system comprises a network station 600, and mobile terminals 630 and 650.

A mobile terminal 630 transmits a setup message 631 to network station 600. The network station 600 transmits a setup message 601 to mobile terminal 650. The mobile terminal 650 is informed that an incoming call is sent from mobile terminal 630 upon receiving the setup message 601. A procedure 651 is performed in mobile terminal 650, wherein the procedure 651 includes the implementation of the method of FIG. 2, 4A, or 4B. The mobile terminal 650 send a disconnect message 653 to the network station. The disconnect message 653 specifies the user-defined disconnect cause selected in FIG. 2, 4A, or 4B. The network station relays disconnect message 653 to mobile terminal 630. The user of mobile terminal 630, i.e., the caller, is informed of the disconnect cause specified in the disconnect message 653. As a result, if the receiver adopts “an invalid number format” as the disconnect cause, the caller is informed that the called phone number is invalid number format; if the receiver adopts “changed number” as the disconnect cause, the caller is informed that the called phone number has been changed; if the receiver adopts “temporary network failure” as the disconnect cause, the caller is informed that the call cannot be placed because of a temporary network failure.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A call processing method implemented in a mobile communication terminal, comprising:
providing at least one entry of caller information;
providing at least one disconnect cause;
associating one of the at least one entry of caller information with one of the at least one disconnect cause;
receiving an incoming call;
determining whether the incoming call is associated with the caller information;
disconnecting the incoming call if the incoming call is associated with the caller information; and
sending a disconnect message indicating the disconnect cause to a network station relaying the incoming call.

2. The method of claim 1, wherein the caller information specifies caller identification information of the incoming call, and disconnecting the incoming call associated with the caller identification information.

3. The method of claim 2, wherein the caller identification information specifies a telephone number and/or caller name for identifying a caller.

4. The method of claim 2, further receiving the caller identification information from a user interface in response to user input, and associating the received caller identification information with one of the provided disconnect cause.

5. The method of claim 2, further selecting the caller identification information from a pre-stored phonebook or a call log in response to a user command, and associating the selected caller identification information with one of the provided disconnect cause.

6. The method of claim 1, wherein the caller information specifies a time period, and disconnecting the incoming call received during the time period.

7. The method of claim 4, further setting the time period in response to a user input, and associating the set time period with one of the provided disconnect cause.

8. The method of claim 1, further caching information pertaining to the incoming call as a missed call for later retrieval.

9. The method of claim 1, wherein the disconnect cause specifies an invalid number format, changed number, or temporary network failure.

10. The method of claim 1, wherein the disconnect message is a disconnect, release, or release complete message as defined in the 3GPP (Third Generation Partnership Project) standard.

11. A call processing method implemented in a mobile communication terminal, comprising:
providing a plurality of disconnect causes;
receiving an incoming call;
prompting a user to select one of the plurality of disconnect causes;
disconnecting the incoming call; and
sending a disconnect message indicating the selected disconnect cause to a network station relaying the incoming call.

12. The method of claim 11, further prompting the user to determine whether to disconnect the incoming call.

13. The method of claim 11, further disconnecting an initiated call during a call session.

14. The method of claim 11, wherein the incoming call is disconnected before a call session is initiated.

15. The method of claim 11, wherein the disconnect cause specifies an invalid number format, changed number, or temporary failure.

16. The method of claim 13, further caching information pertaining to the incoming call as a received call for later retrieval.

17. The method of claim 11, further caching information pertaining to the incoming call as a missed call for later retrieval.

18. The method of claim 11, wherein the disconnect message is a disconnect, release, or release complete message as defined in the 3GPP (Third Generation Partnership Project) standard

19. A mobile communication terminal, comprising:
a storage unit storing at least one entry of caller information and at least one disconnect cause, wherein one of the at least one entry of caller information is associated with one of the at least one disconnect cause;
a communication unit receiving an incoming call; and
a controller determining whether the incoming call is associated with the caller information, disconnecting the incoming call if the incoming call is associated with the caller information, and sending a disconnect message indicating the disconnect cause to a network station relaying the incoming call.

20. The method of claim 19, wherein the storage unit stores the caller information specifying caller identification information of the incoming call, and the controller disconnects the incoming call associated with the caller identification information.

21. The system of claim 20, wherein the storage unit stores the caller identification information specifying a telephone number and/or caller name for identifying a caller.

22. The system of claim 20, wherein the storage unit stores the caller identification information received from a user interface in response to user input, and the received caller identification information is associated with one of the pre-stored disconnect cause.

23. The system of claim 20, wherein the storage unit stores the caller identification information selected from a pre-stored phonebook or a call log in response to a user command, and the selected caller identification information is associated with one of the pre-stored disconnect cause.

24. The system of claim 19, wherein the storage unit stores the caller information specifying a time period, and the controller disconnects the incoming call received during the time period.

25. The system of claim 24, wherein the storage unit stores the time period, which is determined in response to a user input, and the determined time period is associated with one of the provided disconnect cause.

26. The system of claim 19, wherein the storage unit further caches information pertaining to the incoming call as a missed call for later retrieval.

27. The system of claim 19, wherein the storage unit stores the disconnect cause specifying an invalid number format, changed number, or temporary network failure.

28. The system of claim 19, wherein the disconnect message is a disconnect, release, or release complete message as defined in the 3GPP (Third Generation Partnership Project) standard.

29. A mobile communication terminal, comprising:
a storage unit storing a plurality of disconnect causes;
a communication unit receiving an incoming call; and
a controller prompting a user to select one of the plurality of disconnect causes, disconnecting the incoming call, and sending a disconnect message indicating the selected disconnect cause to a network station relaying the incoming call.

30. The system of claim 29, wherein the controller further prompts the user to determine whether to disconnect the incoming call.

31. The system of claim 29, wherein the controller further disconnects an initiated call during a call session.

32. The system of claim 29, wherein the controller further disconnects the incoming call before a call session is initiated.

33. The system of claim 29, wherein the storage unit further stores the disconnect cause specifying an invalid number format, changed number, or temporary failure.

34. The system of claim 29, wherein the storage unit caches information pertaining to the incoming call as a missed call for later retrieval.

35. The system of claim 32, wherein the storage unit further caches information pertaining to the incoming call as a missed call for later retrieval.

36. The system of claim 29, wherein the disconnect message is a disconnect, release, or release complete message as defined in the 3GPP (Third Generation Partnership Project) standard.
